(19) United States
(12) Patent Application Publication
(10) Pub. No.: US 2022/0034804 A1
(43) Pub. Date: Feb. 3, 2022

(54) REFRACTOMETER

(71) Applicant: Jan KÅHRE, Helsingfors (FI)

(72) Inventor: Jan KÅHRE, Helsingfors (FI)

(21) Appl. No.: 17/390,388

(22) Filed: Jul. 30, 2021

(30) Foreign Application Priority Data
Jul. 31, 2020 (FI) 20205777
Nov. 30, 2020 (FI) 20206219

(51) Int. Cl. G01N 21/41; G02B 5/04

(52) U.S. Cl. CPC G01N 21/4133; G01N 2021/414; G02B 5/04

(57) ABSTRACT

The present disclosure embodies a refractometer that includes an embodied fitting to the standardized probe with the optical structure to facilitate refractometer optics to the probe tip.

### CROSS-REFERENCE TO RELATED APPLICATIONS

This application claims priority to Finnish Application No. 20205777 filed Jul. 31, 2020 and Finnish Application No. 20206219 filed Nov. 30, 2020, the entire contents of each of which are hereby incorporated by reference.

In general, the disclosure of the presently embodied invention relates to the field of optics, but in more specifically to the process refractometers, and even in more specifically to a refractometer with its structure that has been disclosed in the preamble part of an independent claim directed thereto.

### BACKGROUND

A process refractometer measures optically the refractive index of a process liquid in line. A prism forms the interface between the optics and the process liquid.

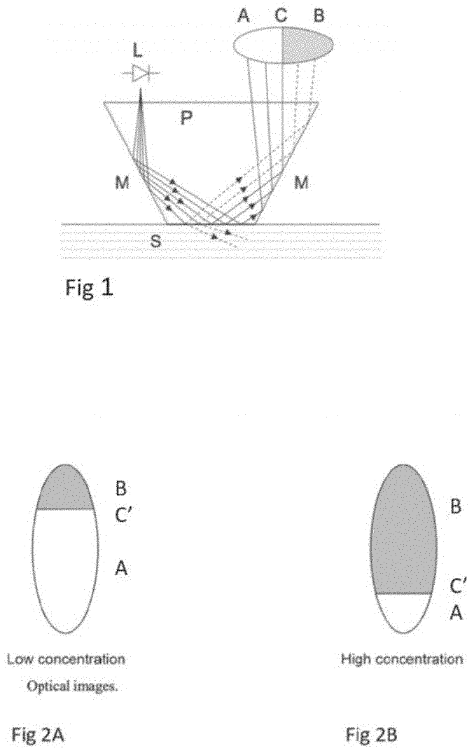

With reference to FIG. 1, in general about the operating principle of a refractometer, the refractometer determines the refractive index RI of the process liquid by measurement of the critical angle of total reflection. Light from the light source (L) in FIG. 1 is directed to the interface between the prism (P) and the process medium (S) by two prism surfaces (M) acting as mirrors bending the light rays so that they meet the interface at different angles.

With a reference to FIG. 2A and FIG. 2B, to illustrate optical images by refractometer, the refractive index RI can then be determined from the position of the shadow edge C′, which can be transformed to an electrical signal e.g. with a CCD array camera. The refractive index RI changes with the process solution concentration. Normally the refractive index RI increases when the concentration increases. From the follows that the concentration of the process liquid can be read from the optical images (FIG. 2A, FIG. 2B).

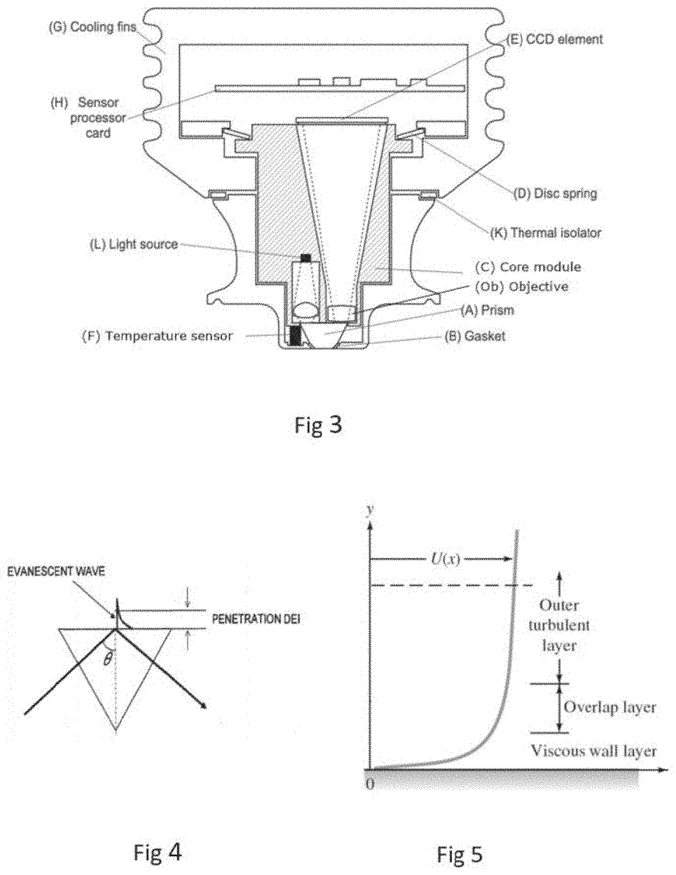

The refractive index depends on the concentration and the temperature of the process liquid. Hence, to measure concentration, both refractive index and the temperature must be measured. Much effort has been spent on design of the refractive index measurement. But the temperature measurement has been seen as a matter of routine, a temperature sensor has been inserted more as an afterthought (FIG. 3).

The critical angle evanescent rays do not penetrate far into the process liquid. The penetration depth by an evanescent wave is of the order of the wavelength of the light source (FIG. 4). In FIG. 4 the critical angle of total reflection has being shown. Hence, the liquid sample to be measured is a thin film on the prism surface. The temperature probe has to measure the temperature of this film as accurately as possible.

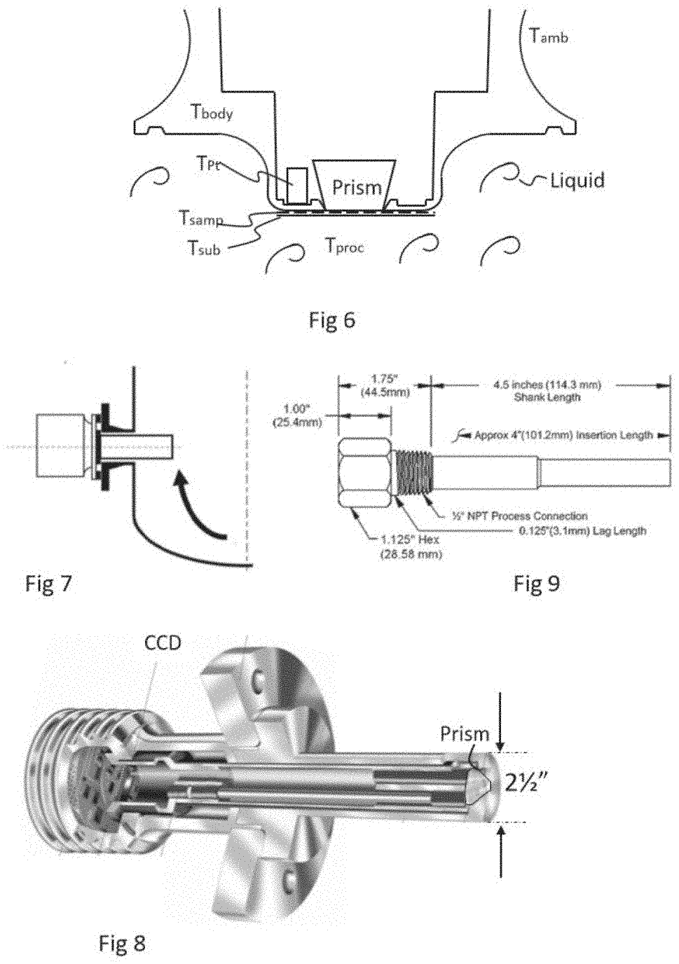

The measurement by the temperature sensor (FIG. 3) is compromised by a hydrodynamic fact: There is a stationary fluid layer at the prism surface (FIG. 5). It is called laminar sublayer or viscous wall layer. In the Outer turbulent region (FIG. 5), temperature differences even out by mixing. The laminar layer has an insulating effect, the transport of heat is by the slow process of conduction. This effect is well known in the engineering calculations of heat transfer from a flowing liquid to a wall. The thickness of the sublayer can be of the order of 1 mm. That's three order of magnitudes larger than the sample layer of the evanescent waves. The sample layer is well within the laminar sub-layer (FIG. 6). An overlapping layer has been indicated in FIG. 5 therebetween the outer turbulent layer and viscous wall layer. In FIG. 5 distance from wall y has being indicated as well as the flow velocity U(x), (the vertical axis is x-axis).

A refractometer then measures at a surface, when other common concentration meters, such gravity or conductivity meters, measure in the volume. The temperature in the volume is well mixed and making the process temperature the relevant measure calculating the concentration. The measurement of surface temperature is a more complicated task and is worth further study to be mentioned with reference to FIG. 6.

When there is a difference between the process temperature and the ambient temperature, there is a heat flow through the refractometer, causing a temperature gradient. We have in FIG. 6 illustration T_{amb} ambient temperature, T_{body} refractometer body temperature, T_{Pt} temperature measured by Pt element, Tₛₐₘₚ the thin sample film temperature, T_{sub} the laminar sublayer temperature, T_{proc} the process temperature. Typically, the process temperature is higher than the ambient. Then we have the relation

T_{amb}<T_{body}<T_{Pt}<Tₛₐₘₚ<T_{sub}<T_{proc} (1)

An important observation is that the sample temperature Tₛₐₘₚ is always between the measured temperature T_{Pt} and the process temperature T_{proc} independently of the heat flow direction. Conclusion: The closer the measured temperature is to the process temperature, the better for the representation of the prevailing conditions in the process location.

If the process temperature is too high for the electronics, it means an additional challenge. There will be a need for the refractometer head to be designed with cooling fins (FIG. 3). This will increase the heat flow through the refractometer. The cross section shows a thermal isolator breaking that flow, and thereby improving the temperature measurement of the sample.

A probe type refractometer (FIG. 7) is far better design from the thermal design point of view. The probe takes the process temperature, and the influence of the ambient temperature on the measurement mostly eliminated.

But even the probe type refractometer of FIG. 7 has its handicap. With changing process temperature, the probe temperature may be slow to follow, due to the heat capacity of the probe. Then the temperature measured by the Pt-element differs from the process temperature, with the sample temperature somewhere in between. For a probe with higher heat capacity, it has turned out that the process temperature may be better indicator of the sample temperature.

The refractometer in FIG. 8 has a probe diameter of 2½ inch, which is considered small. The probe heat capacity would be reduced if the probe diameter had been made smaller. On the other hand, a too thin probe would not stand the forces from the process flow. To find the optimum diameter of a probe, we have to turn to the praxis of industrial temperature measurement.

### SUMMARY

The applicant has come to the conclusion that a ubiquitous tip diameter of a thermowell that is established in the industrial temperature measurement to be ½″ or 12.7 mm, A probe diameter of ½″ would mean an optimal thermal design to a thermowell by the realization that it can be applied to a process refractometer. Such a design would provide a surprising effect that the process operator can get further information from the process location from which earlier mere temperature was available, but now when an embodied refractometer being used to replace the temperature probe by the refractometer in a temperature probe measures, process concentration can be also measured in addition to the temperature. The optical design as embodied is making it now possible to manufacture the refractometer into the industrial measures of ½″ and/or 12 mm.

A small diameter probe is thermally optimal, but mechanically susceptible to forces by the process liquid flow. The calculation of these forces is overwhelmingly hard. Luckily, the manufacturers of thermowells and Universities have united forces and created the 50 pages standard named Thermowells/Performance Test Codes crucial also to the process refractometer probe mechanical structure. The standard defines how to calculate Flow-Induced Thermowell Stresses, both steady-state (bending) and dynamic (oscillation). In case the calculations may indicate that probe diameter ½″ is too small for the flow forces as such, alternatively a step-shank according to FIG. 9 or a suitable tapered design can be used, to meet the flow mechanical requirements for the housing of a refractometer in a thermowell probe.

Moreover, a computer programs were made to facilitate the force calculations for thermowells. A refractometer manufacturer not adopting the accepted probe shapes of a thermowell (FIGS. 9, 18 a, b, c) is left with two options: Either make the probe diameter larger, making temperature measurement too sluggish for industrial acceptance, or trying the formidable task to create a program to calculate the flow forces.

Like a thermowell (FIG. 9), a thread connection can be used for a ½″ refractometer probe. A thread connection is more economical and has less thermal capacity than the flanges and clamps of larger probe diameters (FIG. 8).

Most users already have temperature measurement. Because of the embodiments, the process operators can directly replace the thermowell with a refractometer, thus getting temperature and concentration measurements in the same probe.

There has been known attempts to simply scale down the optics from a 2½″ probe (FIG. 8) to a ½″ probe, that's by a factor of a five reduction in size. Here the minuscular optical components get difficult to handle mechanically, and moreover the optical accuracy is limited by diffraction. That explains why refractometers with less than 1″ probe diameter are not known on the market.

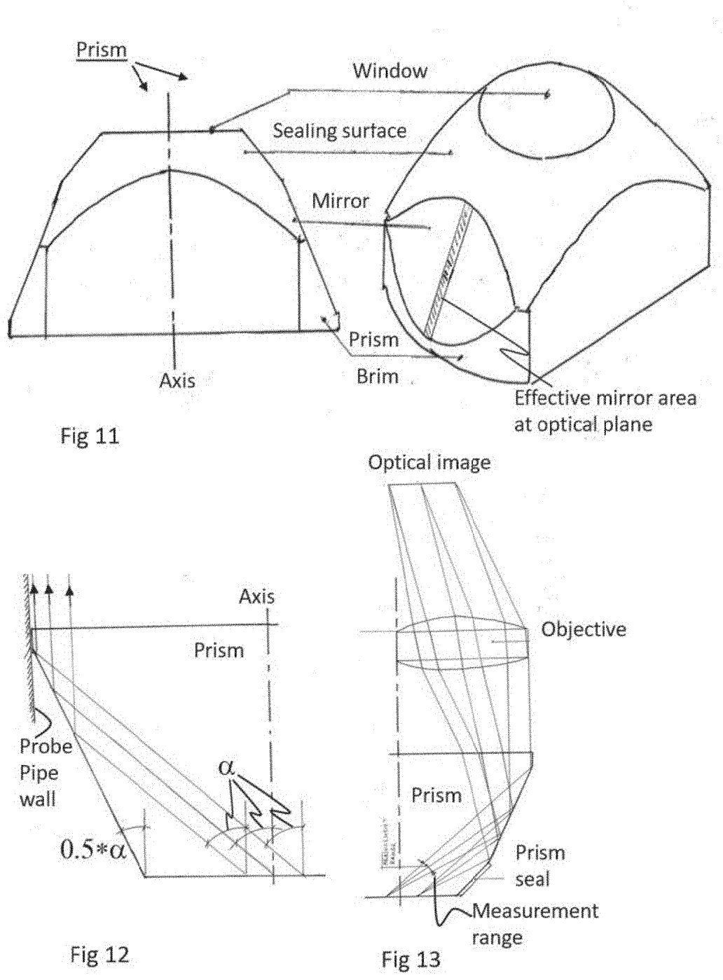

The embodiment of a ½″ probe present a solution to those optical problems. The novel prism has a circular brim (FIG. 11) that snugly fits the inner wall of the probe. That means that the prism is of maximum size, with a full-length mirror. It's cheaper to make, as it is manufactured out of a cylinder.

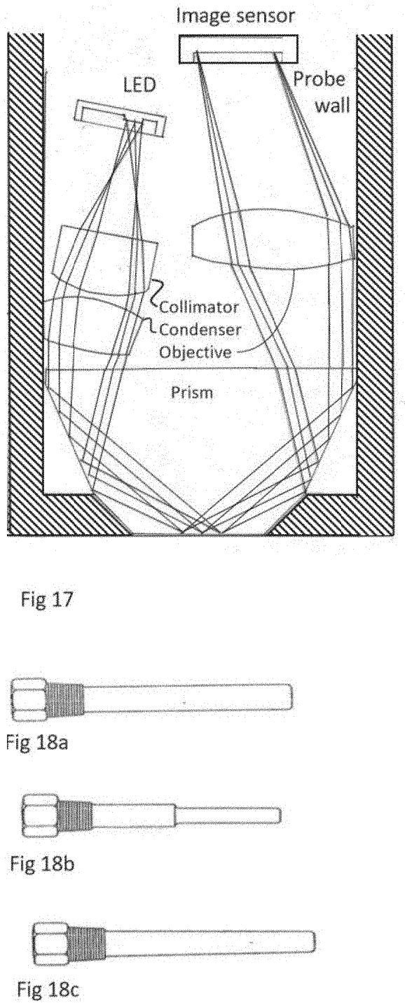

A special optics bends the light rays inwards from the pipe walls (FIG. 17). The result of this arrangement is that all optical elements fills the available space within the pipe wall as efficient as is realizable. The sizes of the lenses and the prism are maximized, and with this novel structure, the lenses are the size of normal catalogue items from lens suppliers. In practice no diffraction happens at this scale.

Yet, there is another aspect of the embodied refractometer probe diameter. In the pharmaceutics industry, a probe diameter of 12 mm is a standard for measurement of pH. A refractometer with a 12 mm probe would be advantageous, because it can be installed in standard certified pharmaceutical fittings, which is another surprising effect of the embodiments of the invention.

Therefore, an exactly 12 mm diameter refractometer is optimal in two ways: for replacement of a thermowell as such, and for use in the pharmaceutical industry. No such refractometer is known before.

A refractometer according to an embodiment of the invention in the present disclosure is characterized in that it has a probe tip diameter of ½″ or 12 mm.

The refractometer according to an embodiment of the present disclosure comprises at least one of the following:
a prism, fitting to a probe having a tip diameter of 12 mm or ½″.
at least one light source,
a condenser lens,
a collimator lens,
a prism seal,
an imaging device, and
an interface to peripheral devices to communicate with the refractometer.

The refractometer according to an embodiment of the present disclosure is a process refractometer adapted to temperature measurements with a probe shaped as a thermowell.

The refractometer according to an embodiment of the present disclosure comprises such a prism that has a circular brim, to fit into a probe of ½″ or 12 mm, according to the internal diameter.

The refractometer according to an embodiment of the present disclosure has such a prism that is mounted into the tip of the refractometer, the prism as being limited between the prism's seal and the brim of the prism at the opposite end as the mirror of the prism.

The refractometer according to an embodiment of the present disclosure has such a prism that has a mirror that has a mirror surface angle to the symmetry axis that is at half the steepest measurement angle (α), to direct the reflected rays to leave the prism surface at a right angle parallel to the probe tip pipe inner wall.

The refractometer according to an embodiment of the present disclosure comprises an objective lens in position to create an optical image in a plane perpendicular to the axis of the prism, where the rays of the same measurement angle are focused on its own point of the image.

The refractometer according to an embodiment of the present disclosure comprises such a condenser lens that have conical sides to fit closely to the bore of the probe.

The refractometer according to an embodiment of the present disclosure is adapted to be used with a retraction device as a certified device to remove a 12 mm probe from the process line in an embodied refractometer system

A use of a refractometer according to an embodiment of the present disclosure is a use of such a refractometer in a pharmaceutical process.

The expression “a number of” refers herein to any positive integer starting from one (1), e.g. to one, two, or three.

The expression “a plurality of” refers herein to any positive integer starting from two (2), e.g. to two, three, or four.

The expression “to comprise” has been used as an open expression.

Different examples on embodiments of the present disclosure of embodiments of the invention are disclosed in the dependent claims.

### SHORT DESCRIPTION OF FIGS

FIGS. 1 to 10 illustrate background techniques as such and the optical aspects thereof as such. In the following, embodiments of the present invention are disclosed with reference to the FIGS. 11 to 18, in which

FIG. 11 illustrates an example of a prism of an embodied refractometer optics, in combination to one or more embodiments,

FIG. 12 illustrates ray path example in an embodied prism, in combination to one or more embodiments,

FIG. 13 illustrates further ray path examples about angles of reflected rays, in combination to one or more embodiments,

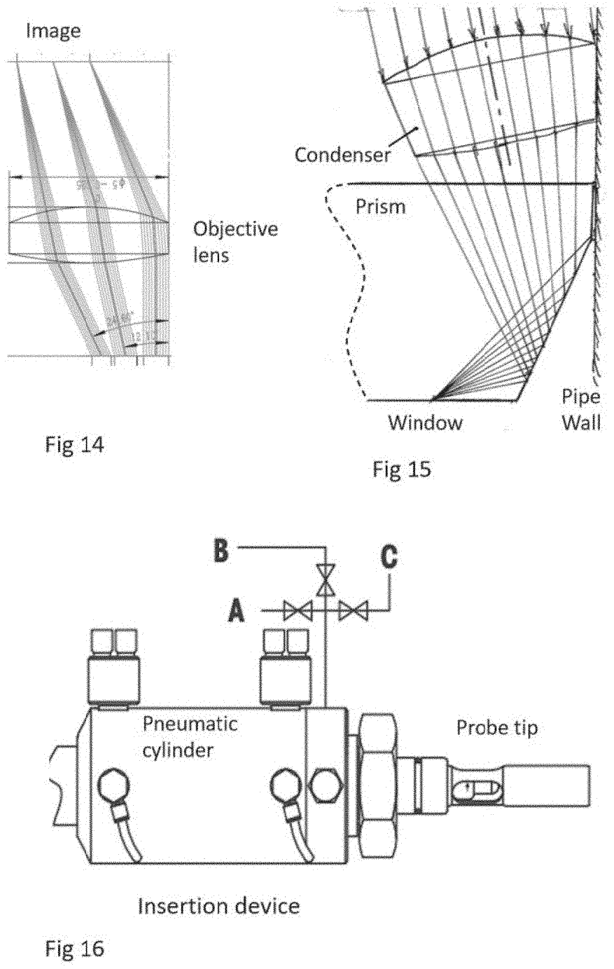

FIG. 14 illustrates objective lens in duty according to an embodied refractometer, in combination to one or more embodiments,

FIG. 15 illustrates a condenser lens example of an embodied refractometer, in combination to one or more embodiments,

FIG. 16 illustrates an embodied example of an embodied refractometer system, comprising an embodied refractometer and a certified device to remove a 12 mm probe from the process line, in combination to one or more embodiments,

FIG. 17 illustrates total optics in an embodied refractometer, in combination to one or more embodiments,

FIGS. 18a, 18b and 18c illustrate examples on thermowell probe geometries as such.

### DETAILED DESCRIPTION OF EMBODIMENT EXAMPLES OF THE PRESENT DISCLOSURE

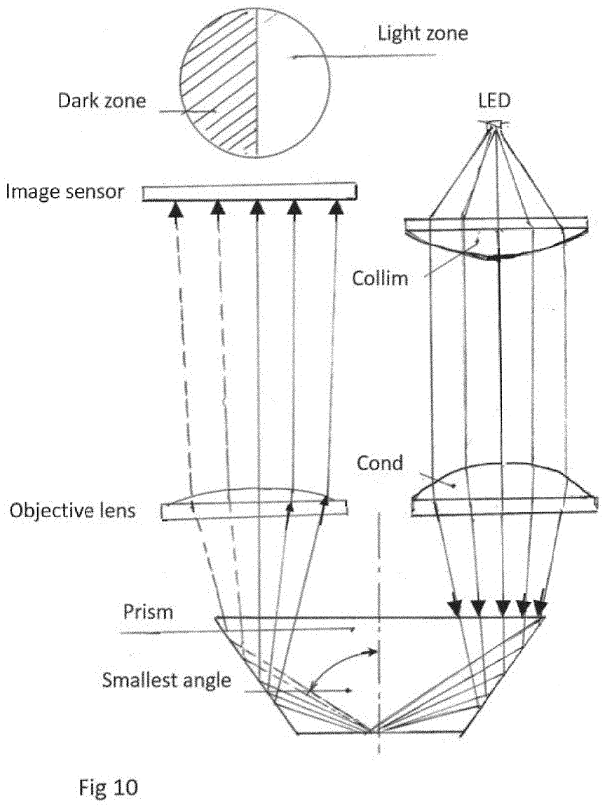

According to an embodiment of the present disclosure, the design goal has been made by the prism of a refractometer optics as exemplified in FIG. 10, as comprising a large prism as possible in a 12 mm probe. It means that the prism has fit snugly into the bore of the thermowell or a similar probe.

That structure sets the design condition on the prism that the brim is advantageously circular with the same diameter as the inner diameter of the pipe according to FIG. 11. Moreover, the efficient mirror area is advantageous to have maximized. That is, the effective mirror area is limited by the prism seal in one end, and by the brim of the prism in the other end.

But it's not only the prism that have to fit into the bore, that goes also for the whole optics as well (FIG. 17), in contrast to FIG. 10. That is, no incoming or outgoing light rays may bend outwards from the prism brim. And the lenses must stay inside the bore, too. In FIG. 17 embodiment example the optical axis of the lenses shown (collimator, condenser and objective) are tilted in respect to the probe longitudinal central axis, the last mentioned being in alignment in an embodiment with (straight) probe walls of the 12 mm or ½″ probe.

To stay within the probe pipe, the rays with the steepest measurement angle α as illustrated in FIG. 12, are critical. When the mirror surface angle to the symmetry axis is at half the steepest angle, the reflected rays leaves the prism surface at a right angle parallel to the pipe inner wall. For greater angles, the reflected rays turn away from the wall. The relation between the respective refractive indices (RI, sample and prism):

sin(α)=RIₛₐₘₚₗₑ/RIₚᵣᵢₛₘ (2)

The equation (2) shows that the steepest angle corresponds to the smallest RI to be measured from the sample.

FIG. 13 exemplifies the angles reflected from two points on the prism's wetted surface. The measurement range is indicated: The steepest angle represents the lowest measured RI value, limited by the brim of the prism. The lowest angle represents the highest measured RI value, limited by the prism seal. The optics forming the optical image by the objective lens is no longer as simple and regular as in FIG. 10.

The objective lens must create an optical picture in a plane perpendicular to the axis of the prism, where the rays of the same measurement angle are focused on its own point of the image. In fact, no ordinary spherical lens can do that. The shape of both of the convex surfaces must be precisely calculated, and the lens must be cast to its special form (FIG. 14).

The light source optics is made with two lenses as in FIG. 10, the convex surfaces of the lenses are spherical, as normally. But the condenser lens is otherwise special (FIG. 15) in embodiments, because it must have conical sides to fit closely to the bore of the probe. Then it handles also the light rays entering the prism adjacent to the inner pipe wall. The collimator lens is merely a standard planoconvex lens from a catalogue. The condenser, the collimator and the light source have the same tilted axis in common (FIG. 17). As the measured sample is a thin film of process liquid on the prism window surface, the refractometer can be sensitive to fouling. If there is a layer of impurities on the prism window, the refractometer measures the impurities, instead of the process liquid. In most applications, a prism cleaning nozzle is installed close to the prism, blowing steam or water on the surface.

In e.g., pharmaceutical fermentation, no cleaning medium is allowed into the process liquid.

In that case, a 12 mm diameter probe has an additional advantage as it can be used by an existing retraction device. An insertion device can will be used to withdraw the probe tip into an internal chamber where it is isolated from the process liquid (FIG. 16). Steam blows in at B, air for drying at A, blow-out at C. Such an embodied refractometer with its probe is embodied as a refractometer system having a retraction device with its pneumatic cylinder.

1. A refractometer comprising a probe tip diameter of ½″ or 12 mm.

2. The refractometer according to claim 1, wherein the refractometer comprises at least one of the following:
a prism, fitting to a probe having a tip diameter of 12 mm or ½″.
at least one light source,
a condenser lens,
a collimator lens,
a prism seal,
an imaging device and
an interface to peripheral devices to communicate with the refractometer.

3. The refractometer of claim 1, wherein the refractometer is a process refractometer adapted to industrial temperature measurement by the probe taking the shape with the measures of a thermowell.

4. The refractometer according to claim 1, wherein the prism has a circular brim, to fit the inner diameter of ½″ or 12 mm probe.

5. The refractometer according to claim 1, wherein the prism is mounted into the tip of the refractometer, the prism mirror stretching from the prism's seal to the brim.

6. The refractometer according to claim 1, wherein the prism has a mirror that has a mirror surface angle to the symmetry axis that is at half the steepest measurement angle (α), to direct the reflected rays to leave the prism surface at a right angle parallel to the probe tip pipe inner wall.

7. The refractometer according to claim 1, wherein the refractometer comprises an objective lens in position to create an optical image in a plane perpendicular to the axis of the prism, where the rays of the same measurement angle are focused on a given point of the image.

8. The refractometer according to claim 1, wherein the refractometer comprises such a light source condenser lens that has conical sides to fit closely to the bore of the probe.

9. The refractometer according to claim 1, wherein the refractometer comprises rod-lenses in a plurality of lenses arranged one after the other for transmitting the optical image outside the narrow probe.

10. The refractometer according to claim 1, wherein the refractometer is adapted so as to be suitable for use with an available pharmaceutical retraction device for 12 mm diameter probe.

11. A method for carrying out a pharmaceutical process, wherein the method comprises providing the refractometer of claim 1, installing the refractometer by a standard pH connector, and applying the refractometer to the pharmaceutical process.

12. The refractometer of claim 2, wherein the refractometer is a process refractometer adapted to industrial temperature measurement by the probe taking the shape with the measures of a thermowell.

13. The refractometer according to claim 2, wherein the prism has a circular brim, to fit the inner diameter of ½″ or 12 mm probe.

14. The refractometer according to claim 3, wherein the prism has a circular brim, to fit the inner diameter of ½″ or 12 mm probe.

15. The refractometer according to claim 2, wherein the prism is mounted into the tip of the refractometer, the prism mirror stretching from the prism's seal to the brim.

16. The refractometer according to claim 3, wherein the prism is mounted into the tip of the refractometer, the prism mirror stretching from the prism's seal to the brim.

17. The refractometer according to claim 4, wherein the prism is mounted into the tip of the refractometer, the prism mirror stretching from the prism's seal to the brim.

18. The refractometer according to claim 2, wherein the prism has a mirror that has a mirror surface angle to the symmetry axis that is at half the steepest measurement angle (α), to direct the reflected rays to leave the prism surface at a right angle parallel to the probe tip pipe inner wall.

19. The refractometer according to claim 3, wherein the prism has a mirror that has a mirror surface angle to the symmetry axis that is at half the steepest measurement angle (α), to direct the reflected rays to leave the prism surface at a right angle parallel to the probe tip pipe inner wall.

20. The refractometer according to claim 4, wherein the prism has a mirror that has a mirror surface angle to the symmetry axis that is at half the steepest measurement angle (α), to direct the reflected rays to leave the prism surface at a right angle parallel to the probe tip pipe inner wall.
